(19) United States
(12) Patent Application Publication
(10) Pub. No.: US 2008/0236849 A1
(43) Pub. Date: Oct. 2, 2008

(54) Machine for Working the Soil and Deflector Device Adapted to be Used on Such a Machine

(76) Inventor: Michel Evin, Ligne (FR)

Correspondence Address: YOUNG & THOMPSON, 209 Madison Street, Suite 500, ALEXANDRIA, VA, 22314, US

(21) Appl. No.: 10/586,258

(22) PCT Filed: Jan. 17, 2005
(86) PCT No.: PCT/FR05/00098

§ 371 Date: Sep. 12, 2006

(30) Foreign Application Priority Data
Jan. 19, 2004 (FR) 0400458

(51) Int. Cl. A01B 35/18

(52) U.S. Cl. 172/112

(57) ABSTRACT

A soil working machine, particularly a precision tiller, includes a chassis (1) equipped with tillage implements provided in the form of at least one, preferably two successive train(s) of non-driven discs (2, 3) and of at least one deflecting device (4) serving to break the flow of soil projected by the discs (2) of one of the trains of discs (2, 3) and to ensure a leveling of the soil on the ground. The deflecting device (4) is, in its working part corresponding to the area struck by a flow of soil, having a number of plates (5) that can vibrate in order to facilitate a separation of the soil from these plates. The plates (5) are arranged side-by-side in the direction of the width of the machine and are designed so they cover at least 45% of the total working width of the machine.

The present invention relates to a machine for working the soil, in particular a precision disc harrow, of the type comprising a chassis provided with plowing tools comprising at least one, preferably two, successive series of non-driven discs and at least one deflector device shaped to break the flow of dirt projected by the discs from one of the series of discs and thereby to ensure leveling of the dirt with the ground.

Such a machine is particularly described in International application No. WO 02/19702 of the present applicant.

These machines have the characteristic of working at particularly high speeds, often greater than 15 km/h. There results the necessity of positioning a deflector device between the successive series of discs, even to the rear of the second series of discs, so as to prevent either damage to the constituent elements of the machine, or interfering with the working of the soil connected with projections of the flow of dirt. Moreover, there is thus avoided harming any persons in the vicinity of the machine during working of this latter.

Until now, the deflector devices were of two categories. The first category is constituted by a flat projector in the form of a apron shown in the mentioned International application or U.S. Pat. No. 3,768,572. This apron is particularly effective to break the clumps of dirt that are formed and thereby to ensure a leveling function of the dirt. On the other hand, when the ground is moist and the dirt is particularly heavy, it is seen that the dirt has the tendency to cling to the surface of the apron which it has struck, until the assembly is jammed such that after a certain number of passages through the ground, the apron no longer fulfills its function or only imperfectly. Moreover, such aprons are particularly bulky to store. Still further, their production requires knowing in advance the width of the machine to be equipped with such an apron.

Moreover, there are known devices in the form of teeth or fingers positioned behind the series of discs. These teeth or fingers play the role of a screen and have for its object retaining large debris. However, because of their design, generally in the form of a cylindrical body of small diameter, they do not permit retaining the flow of projected dirt which tends to pass between the teeth or fingers. Such devices are thus less effective as clod breakers and do not ensure the function of leveling the ground. However, they have the advantage of not giving rise to problems of clogging mentioned above whilst offering the capacity to stop the largest obstacles.

An example of such a deflector device is described in the patent EP 1 300 060. It will be understood from this document that the large particles are retained by the teeth and hence fall to the ground where they will be covered by the flow of earth projected by the discs of the front series of discs during advance of the machine. This arrangement of the large particles below slender elements is an anti-agricultural arrangement. This arrangement leads to the formation of a crust on the surface in the case of rain. If seeds have been deposited on the surface of the porous ground, there is accordingly a smothering also called “beating” of said seeds. The seeds are found in an environment of straw and large clods unfavorable to their development. A drying of the seeds and absence of germination are noted. As a result, and for the reasons mentioned above, the use of teeth or fingers is to be proscribed. The owner of EP 1 300 060 also envisages the use of plates called “rebound plates”. However, these plates are neither described nor shown. It can be imagined, so that these plates have an effect similar to the teeth or fingers, that the plates will be positioned perpendicularly to the direction of advance of the chassis, the attack edge of the plate being formed by the section of said plate.

An object of the present invention is thus to propose a machine for working the soil and a deflector device adapted to equip such a machine, whose designs permit breaking the flow of dirt projected by the discs of the machine without giving rise to clogging or accumulating dirt on the surface of the deflector, whilst preventing the passage of almost all the flow of dirt beyond the deflector.

Another object of the present invention is to propose a machine for working the ground and a deflector device adapted to equip such a machine whose designs permit the adaptation of such a deflector device to machines having different working widths.

To this end, the invention has for its object a machine for working the ground, in particular a precision disc harrow, of the type comprising a chassis provided with plowing tools in the form of at least one and preferably two successive series of non-driven discs and at least one deflector device shaped to break the flow of dirt projected by the discs of one of the series of discs and to ensure leveling the dirt to the ground, characterized in that the deflector device is, in its working portion, corresponding to the region struck by a flow of dirt, constituted by a plurality of plates adapted to oscillate preferably resiliently particularly under the action of a flow of dirt, to facilitate declogging of the dirt from said plates, these plates being disposed side by side in the direction of the width of the machine and dimensioned to cover at least 45%, preferably at least 60%, of the total working width of said machine.

Thanks to the design of the deflector device in the form of an oscillatory plate or resilient blade adapted to oscillate, either under the influence of movement of the machine, or under the influence of a fill dirt projected against the surface of said plate or blade, there is avoided the formation of a mass of dirt on the surface of the plate that is struck by the flow of dirt and accordingly the buildup of clogging observed with the conventional apron whose dimensions and design are in the form of an element of a single plain piece covering the whole width of the machine, thereby preventing relative movement of this latter and accordingly leading to rapid clogging of this latter.

The provision of the deflector device in the form of a plurality of plates permits obtaining, from the flow of dirt striking the plates, a deposit on the ground of fine particles which are then covered by the residues of the harvest or the larger particles. This arrangement of “fine particles covered with larger elements” is an agronomical arrangement which promotes the growth of seeds by protecting these latter with the help of coarser particles. Such an effect is contrary to that obtained with teeth. This effect can be obtained only if the plates cover at least 45%, preferably at least 60%, of the working width to form a surface equivalent to a plane surface adapted to stop the flow of dirt.

According to a preferred embodiment of the invention, the deflector device is shaped to break the flow of dirt projected by the discs of the series called the front series of discs, is preferably coupled securely in movement with the series called the rear series of discs.

Thus, preferably, the connection means of the plate or a group of plates to the working machine for the soil, extend between the plate or groups of plates and discs of the rear series of discs or connection member of the disc of the rear series to the chassis, thereby rendering the plate or group of plates secured in movement with the member for connection/disc assembly. This design has a large number of advantages. Thus, the plate or group of plates encroaches on the disc of the rear series or following disc such that the size as to length of the plate/disc assembly is reduced. As the plate or group of plates is secured in movement with the disc, the plate or group of plates profits from the safety device of the disc permitting removal of the plate or group of plates in the presence of obstacles in the ground. Finally, thanks to this arrangement, a telescoping of the discs of the front series with the deflector device is rendered more difficult or even impossible.

The invention also has for its object a deflector device of the type shaped to break the flow of dirt projected by the discs of a machine for working the soil, such as a disc harrow, provided with at least one, preferably two successive series of discs, characterized in that the deflector device is, in its working portion corresponding to the region struck by the flow of dirt, constituted by a plurality of plates, adapted to oscillate, preferably resiliently, particularly under the action of the flow of dirt, these plates being positionable side by side in the direction of the working width of the chassis of the machine to be provided by means of connection means to the suitable machine.

Thanks to the design of this deflector device, it becomes possible to provide, in the case of certain embodiments of elements in the form of plates or blades, substantially all the earth-working machines independently of the proposed working width.

Moreover, the design of such a deflector device permits avoiding all the drawbacks resulting from the use of a conventional apron.

The invention will be better understood from a reading of the following description of embodiments, with reference to the accompanying drawings, in which:

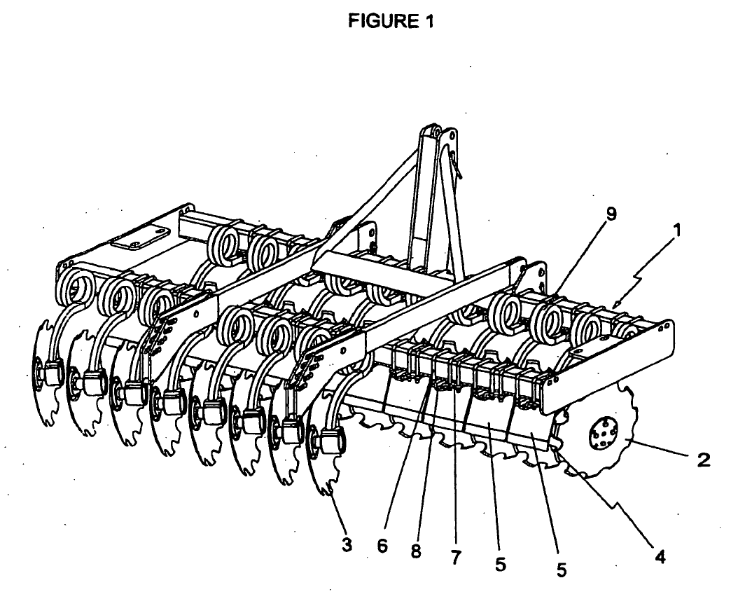

FIG. 1 is a fragmentary perspective view of a machine for working the soil, such as a disc harrow, provided with a deflector device according to the invention;

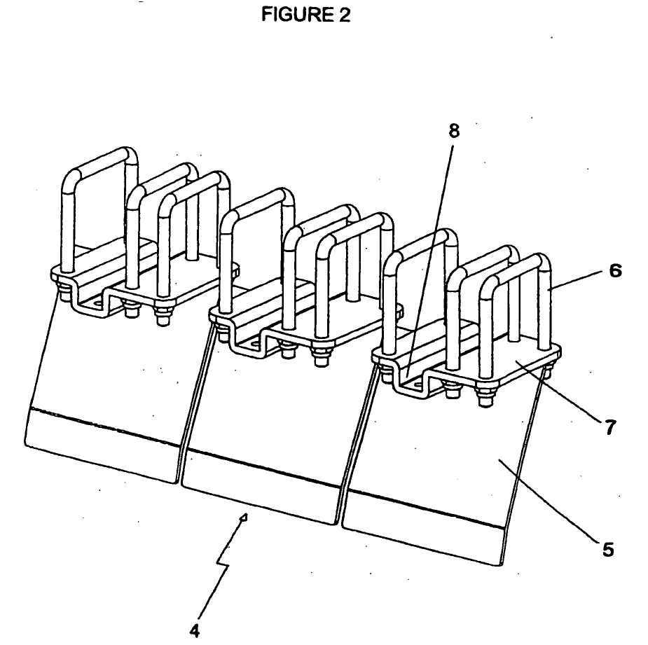

FIG. 2 is a perspective view of elements in the form of a plate or blades, adapted to constitute a deflector device;

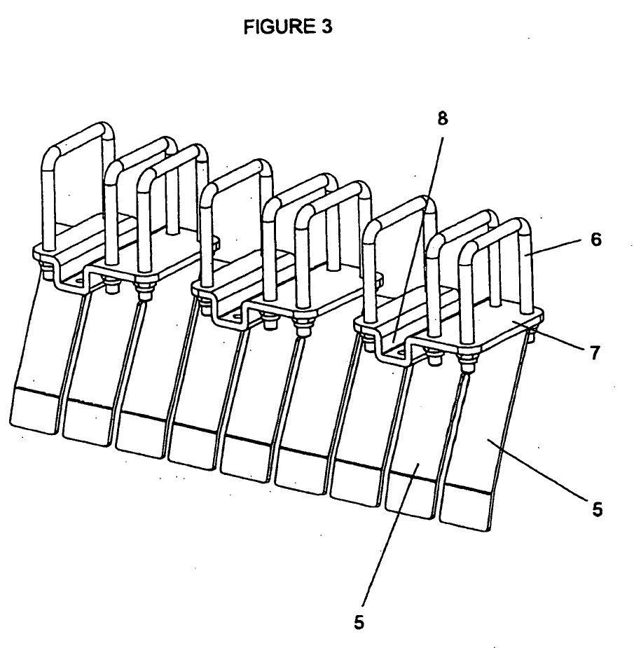

FIG. 3 is a perspective view of another embodiment of elements in the form of plates and adapted to constitute a deflector device;

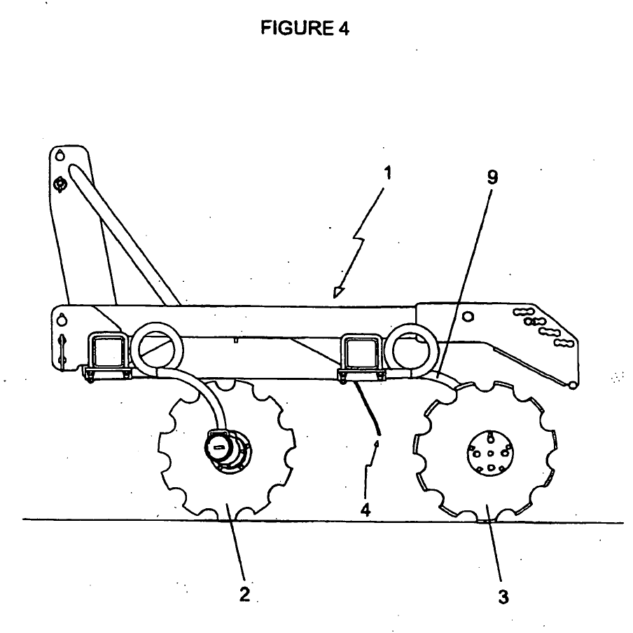

FIG. 4 is a side view of the machine showing FIG. 1;

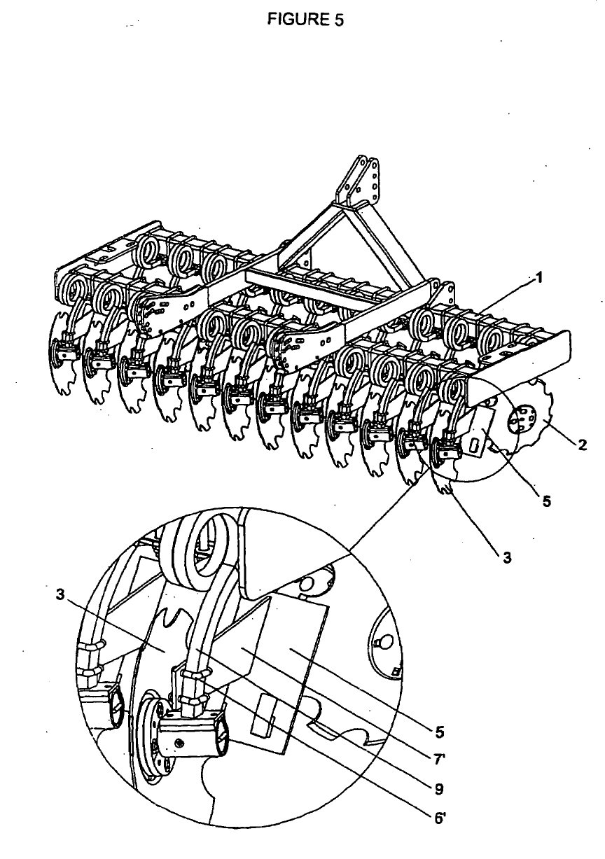

FIG. 5 is a fragmentary perspective view of another embodiment of a machine for working the soil according to the invention with a detailed view of a portion of the deflector device;

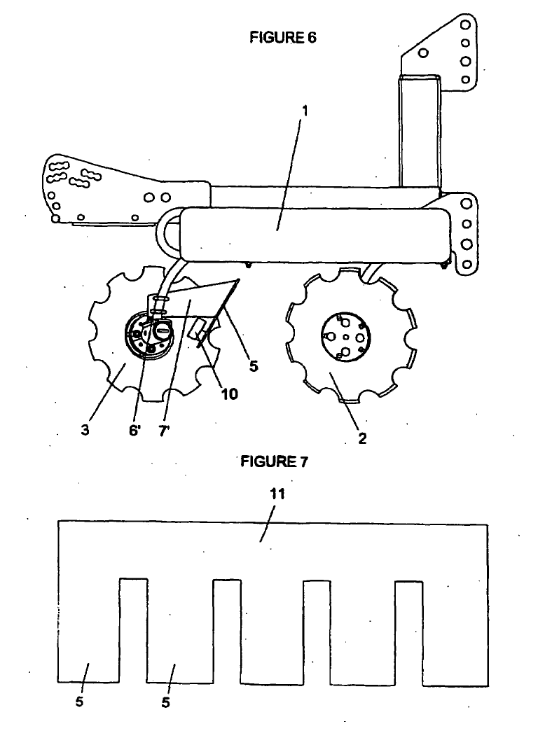

FIG. 6 is a side view of the soil working machine shown in FIG. 5;

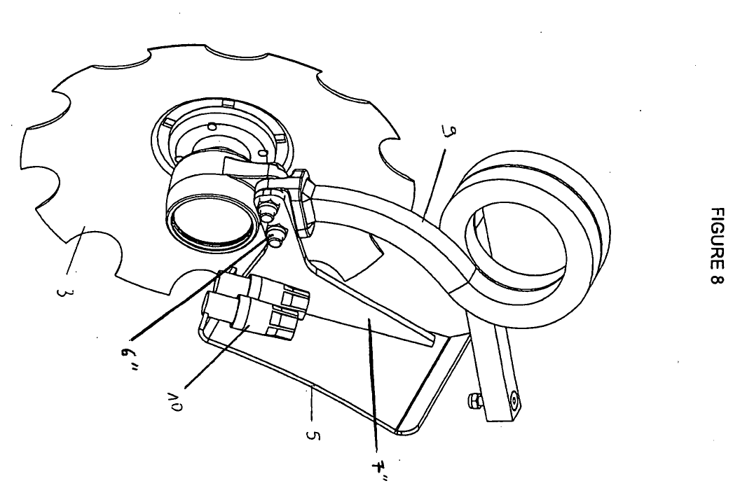

FIG. 7 is a perspective view of a deflector obtained by cutting out a blank and whose plates are prolonged by a common base; and

FIG. 8 is a perspective view of a disk/connecting member/plate deflector assembly.

As mentioned above, the invention relates to a machine for working the soil, in particular a precision disc harrow, of the type shown in FIG. 1. These machines are well known to those skilled in this art. They have particularly a drawn chassis 1, carried or driven, provided with at least plowing tools comprising at least one, preferably two, successive series of harrow discs shown respectively as front discs 2 and rear discs 3. These discs thus extend along a working width of the machine so as to form a series of discs parallel to each other. The design of these discs and their positioning on the chassis 1 of the machine will not be described in greater detail because they are well known to those skilled in this art.

There can also be provided on the chassis 1, generally hitched to a tractive vehicle, at least one device for regulating the working depth of the discs, such as a roller. There is also provided a deflector device shown at 4 in the figures, shaped to break the flow of dirt projected by the discs from one of the series of discs and thereby to ensure leveling of the ground. This or these deflector devices can be disposed between the two series of discs as shown in FIG. 1 or behind each series of discs, a deflector device being in this case adapted to break the flow of dirt projected by the front series of discs whilst another deflector device is adapted to break the flow of dirt projected by the rear series of discs. This deflector device is, in its working portion, corresponding to the region struck by a flow of dirt, constituted by a plurality of elements in the form of plates 5 or blades, adapted to oscillate to facilitate unclogging of the dirt from said plate elements. These plates 5 are thus disposed side by side in the direction of the width of the machine and dimensioned to cover at least 45% of the working width of said machine. Thanks to this dimensioning, the interception of the flow of dirt obtained by means of such plates is equivalent to that obtained by means of a continuous element in the form of an apron that covers all the width of the machine. There results an agronomical disposition of the light particles and of the heavy particles, the heavy particles covering the light particles. The flow of dirt, adapted to pass through this deflector element which it can produce, represents a very small proportion of the flow of projected dirt. Thus, the spaces between two blades are extremely small. Preferably, these spaces are comprised within the range 1 to 500 mm. The value of 150 mm is used when each disc projects between two deflector plates as shown in FIG. 5 so as better to ensure the compactness of the machine. The plates or blades can themselves have various dimensions. In the examples shown in FIG. 1, these plates have a width comprised within the range 5-30 cm whilst in the example shown in FIG. 3, these plates have a width comprised within the range 2 to 15 cm.

Several embodiments of such a deflector device can be used.

In the embodiments shown in FIGS. 1 to 6 and 8, each plate or groups of plates is provided with its own connection means to the rest of the machine so as to be able to be mounted on the machine independently of the other plates or groups of plates. In a first embodiment according to FIGS. 1 to 4, the number of connection means of the plates to the chassis 1 is high. Thus, in FIG. 1, there are as many connection means as plates 5.

In the example shown in FIG. 3, with each connection means is associated a group of plates, here constituted by three plates. Independently of the embodiment used in FIGS. 1 to 4, each time, at least one portion of the connection means 7 of the plate 5 or group of plates 5 to the machine extends between chassis 1 and plate 5 or group of plates 5 and constitutes moreover the short means of a connection member 9 of the disc, located in the rear of said plate 5 or group of plates 5, to the chassis 1 of the machine.

Thus, in these embodiments, the securement means of the plate or group of plates to the chassis are constituted by at least two stirrups 6 adapted to straddle a beam of the chassis 1 and a plate 7 closing the stirrups 6 in the condition positioned on the chassis 1. The plates are thus mounted securely to this plate 7. The connection between the plate and the plate 7 can be of various types. In the illustrated examples, the plates are each time fixed by bolting to the plate 7. It can also be envisaged in an equivalent manner to weld each plate to the plate 7. This plate 7 again has a throat 8 within which is introduced one end of the connection member of the disc to the chassis. This connection member can be constituted by a helicoidal spring 9 with at least one winding, as shown in particular in FIG. 1.

In another embodiment of the deflector device, shown in particular in FIGS. 5, 6 and 8, the connection means 6′, 7′ are 6″, 7″ of the plate 5 or group of plates 5 to the working machine for the ground extend between plate 5 or group of plates 5 and disc 3 or connection member 9 of the disc 3 to the chassis 1. Preferably, the deflector device 4 shaped to break the flow of dirt projected by the discs 2 of the so-called front series of discs is coupled preferably securely to move with the so-called rear series of discs 3. Thus, in this case, as shown in FIG. 5 or FIG. 8, each plate or group of plates of the deflector is connected to the connection member 9 of the disc 3 of the rear series to the chassis 1 by a plate, shown at 7′ or 7″, extending orthogonally to the first plate and bearing on the back of the deflector plate 5. Stirrups, shown at 6′ in FIG. 5, are provided to couple this connection plate 7′, between the deflector plate 7 and helicoidal spring 9, to the helicoidal spring 9. There can be provided in an equivalent manner a securement of this connection plate 7′ of the deflector plate 5 to the hub of the disc 3 of the rear series without departing from the scope of the invention. In the example shown in FIG. 8, the plate 7′ for connection of the deflector plate 5 to the connection member 9 is fixed to the connection member by bolts 6″ which serve moreover for the connection between connection member 9 and the hub of the disc 3 of the rear series.

In another embodiment in which it is desired to reduce the number of connection means of the plates 5 to the machine, each plate 5 can be connected in prolongation of its working portion to a base 11 common to said plates 5, base 11 and working portion of the plates 5 being formed in a single piece. The base 5 is itself adapted to be fixed to the rest of the machine by suitable connection means which can be identical to those described above. This embodiment is more particularly shown in FIG. 7. This deflector device can in this case be constituted by a single sheet metal blank according to FIG. 7 or several sheet metal blanks disposed side by side and similar to that shown in FIG. 7. In this embodiment, the plates and their bases are obtained from a blank of sheet metal of generally rectangular appearance, sectioned over a portion of its width according to a plurality of cutouts that are substantially parallel and spring from a same free edge of the sheet metal blank to form elements in the form of plates. This blank is if desired previously or subsequently to its cutting out, shaped to give it a profile of generally curved appearance. This embodiment has the advantage of simplifying the connection between the plates and the machine.

In the examples shown, and independently of the embodiment used, the plates are aligned along a line substantially perpendicularly to the direction of advance of the chassis and corresponding to the working width of the machine.

In another embodiment (not shown), the plates can be positioned axially offset relative to the direction of advance of the chassis and be for example thus positioned on opposites sides of a line substantially perpendicular to the direction of advance of the chassis and corresponding to the working width of the machine. This offset moreover permits dimensioning the plates such that they overlap at least partially over a portion of their vertical edges. Thus, the drawback which would result from the embodiment in the form of plate elements which give rise to the presence of an empty space between two plate elements, is thus avoided thanks to this overlapping of the plate elements. It could also be envisaged to give to each plate element a particular orientation. Generally these plates are disposed substantially parallel to each other. These plates, which are made from a blank or metallic plate, can be bent adjacent their end adapted to be positioned near the ground as shown in particular in FIG. 3. Obviously, other shapes can be used, in particular a curved shape taking as its reference the curvature of the disc positioned upstream of the deflector device.

In this particular embodiment, the connection means of the plates or group of plates to the machine for working the soil can thus be common to the assembly of plates. The plates 5 of the deflector device can moreover be provided on their back with a seeder when the machine for working the soil, adapted to incorporate such a deflector device, moreover comprises seeding elements.

The deflector device as described above has a certain number of advantages. It permits, in addition to avoiding any risk of clogging, the possibility of adapting to any width of machine, because it is always possible to add an element in the form of a plate to a chassis of the machine in the case of a design according to that shown in FIGS. 1 to 3.

To accentuate the effect of oscillation of the elements in the form of plates or blades as desired, there can be provided, in the region of connection of the element in the form of a blade or plate to the frame, a resiliently deformable element. However, if the dimensions of the plate or blade and the thickness of the metallic blank serving for the provision of the plate or blade are optimized, such a resilient deformable element will not be necessary and an excellent result can be obtained as to oscillation of the elements in the form of plate or blade without the use of an accessory of the type mentioned above.

1. Machine for working the soil, in particular a precision disc harrow, of the type comprising a chassis (1) provided with plowing tools in the form of at least one and preferably two successive series of non-driven discs (2, 3) and at least one deflector device (4) shaped to break the flow of dirt projected by the discs (2) from one of the series of discs (2, 3) and to ensure leveling of the ground,
characterized in that the deflector device (4) is, in its working portion, corresponding to the zone struck by a flow of dirt, constituted by a plurality of plates (5) adapted to oscillate, preferably resiliently, particularly under the action of the flow of dirt, to facilitate dislodging the dirt from said plates, said plates (5) being disposed side by side in the direction of the width of the machine and dimensioned to cover at least 45%, preferably at least 60%, of the total working width of said machine.

2. Machine for working the soil according to claim 1,
characterized in that each plate (5) of group of plates (5), is provided with its own means (6, 7; 6′, 7′; 6″, 7″) for connection to the machine for working the soil to be able to be mounted on the machine for working the soil independently of the other plates (5) or groups of plates (5).

3. Machine for working the soil according to claim 1,
characterized in that at least one portion of the means (7) for connection of the plate (5) or group of plates (5) to the machine extend between the chassis (1) and plate (5) or group of plates (5) and constitute moreover the support means for a member (9) for connection of the disc, located to the rear of said plate (5) or group of plates (5), to the chassis (1) of the machine.

4. Machine for working the soil according to claim 3,
characterized in that the connection means of the plate (5) or group of plates (5) to the chassis (1) are constituted by at least two stirrups (6) adapted to overlap a beam of the chassis (1) and a plate (7) closing the stirrups (6) in the condition positioned on the chassis (1), the elements of plates (5) being mounted securely on said plate (7).

5. Machine for working the soil according to claim 4,
characterized in that the plate (7) has a throat (8) within which is introduced one end of the connection member (9) of the disc (2, 3) to the chassis (1), this connection member (9) being constituted preferably by a helicoidal spring with at least one turn.

6. Machine for working the soil according to claim 1,
characterized in that the deflector device (4) shaped to break the flow of dirt projected by the discs (2) of the front series of discs is coupled preferably securely for movement with the so-called rear series of discs (3).

7. Machine for working the soil according to claim 1,
characterized in that the means (6′, 7′; 6″, 7″) for connection of the plate (5) or group of plates (5) to the machine for working the soil extend between the plate (5) or group of plates (5) and the disc (3) or member (9) for connecting the disc (3) to the chassis (1).

8. Machine for working the soil according to claim 1,
characterized in that each plate (5) is connected in its portion prolonging its working portion to a base common to said plates (5), this base (11) being itself adapted to be secured to the machine, the base (11) and working portion of the plates (5) being formed of a single piece.

9. Machine for working the soil according to claim 8,
characterized in that the plates (5) with their common base are obtained from a blank of sheet metal of generally rectangular appearance, sectioned over a portion of its width into a plurality of substantially parallel cutouts arising from a same free edge of the sheet metal blank to form said elements in the form of plates (5), this blank being if desired previously or subsequently to its cutting out, shaped to give it a generally curved profile.

10. Machine for working the soil according to claim 1,
characterized in that the plates (5) are aligned along a line substantially perpendicular to the direction of advance of the chassis (1), and corresponding to the working width of the machine.

11. Machine for working the soil according to claim 1,
characterized in that the plates (5) are positioned in an axially offset manner relative to the direction of advance of the chassis (1).

12. Machine for working the soil according to claim 1,
characterized in that the plates are provided on their back with a seat depositor (10).

13. Deflector device of the type shaped to break the flow of dirt projected by the discs (2, 3) of a machine for working the soil, such as a disc harrow, provided with at least one, preferably two successive series of discs (2, 3), characterized in that the deflector device is, in its working portion corresponding to the zone struck by a flow of dirt, constituted by a plurality of plates (5) adapted to oscillate, preferably resiliently, particularly under the action of the flow of dirt, these plates (5) being positionable side by side in the direction of the working width of the chassis (1) of the machine to be provided by means of connection means (6, 7; 6′, 7′; 6″, 7″) to the suitable machine.

14. (canceled)
